(19) United States
(12) Patent Application Publication
(10) Pub. No.: US 2013/0210956 A1
(43) Pub. Date: Aug. 15, 2013

(54) Cured Triacylglycerol Oligomers and Methods of Making and Using Same

(71) Applicant: William A. Franks, Langston, OK (US)

(72) Inventor: William A. Franks, Langston, OK (US)

(21) Appl. No.: 13/762,651

(22) Filed: Feb. 8, 2013

Related U.S. Application Data
(60) Provisional application No. 61/597,503, filed on Feb. 10, 2012.

(51) Int. Cl. C09D 11/00

(52) U.S. Cl. CPC C09D 11/00
USPC 522/179; 427/508; 427/517; 427/519

(57) ABSTRACT

A process is disclosed for curing a composition containing a triacylglycerol oligomer which includes exposing the composition to ultraviolet radiation to form a cured product. The composition can also include any or all of the following: a pigment, an initiator, a fatty acid methyl ester, a surfactant, a drying agent, and other additives.

### CROSS-REFERENCE TO RELATED APPLICATIONS

None

### STATEMENT REGARDING FEDERALLY SPONSORED RESEARCH OR DEVELOPMENT

Not applicable.

### FIELD OF THE INVENTION

The present invention relates in general to triacylglycerol oil-based oligomers and oligomer complexes and methods of processing and using same. More particularly, the present invention relates to the curing of such triacylglycerol oligomers and using such in the preparation, production, and use as coatings.

### BACKGROUND OF THE INVENTION

Historically, printing ink has been primarily petroleum based, including 15-25% hydrocarbon or alkyd resin, 50-70% mineral oil solvent, and, for black ink, 15-20% carbon black. The domestic petroleum shortages of the 1970's stimulated research efforts to discover and develop non-petroleum based inks. Also, in the early 1980's, the American Newspaper Publishers Association (“ANPA”) directed a research effort for the development of non-petroleum based newspaper inks. In response to the directives, numerous approaches were taken by researchers including the formulation of vegetable oil-based ink using a combination of petroleum based ingredients and soy bean oil. Widespread use of such inks has been inhibited, however, by the cost, which is 50-70% higher than traditional petroleum-based inks. Despite advances which have been made, the industry is still looking for a non-petroleum-based ink which is cost competitive with traditional petroleum-based ink and similar or better in performance.

While vegetable oil-based inks have certain advantages over petroleum-based inks, such as the crispness of the color, and in some applications, ease of use, one drawback has been the long drying time for such inks. Vegetable oil-based inks containing triacylglycerol oligomers have been found to dry quickly by absorption when applied to non-coated paper, but have very long drying times when applied to any impervious surface such as coated paper. In 1992, U.S. Pat. No. 5,167,704 was granted to Brower which recognized the drying speed issue for soy inks, and wherein non-petroleum based organic solvents were employed to improve such drying speed. There still exists a need for an improved process to decrease the drying time of vegetable oil-based ink, and solve the related issue of rub-off of wet ink on skin or clothes.

The present invention solves the above problems that exist in prior vegetable oil-based printing inks by providing a process which results in faster drying/curing of the vegetable oil-based ink without the need for added drying agents or limiting their application to only non-coated paper.

### SUMMARY OF THE INVENTION

In accordance with an embodiment of the present invention, a process is provided for curing a composition comprising a triacylglycerol oligomer comprising exposing the composition to ultraviolet radiation to form a cured product.

In accordance with an embodiment of the present invention, a cured product is provided which is prepared by curing a composition comprising a triacylglycerol oligomer comprising exposing the composition to ultraviolet radiation.

In accordance with another embodiment of the present invention, a process is provided for applying an ink comprising at least a triacylglycerol oligomer and a pigment to a paper material, and curing the ink by exposure to ultraviolet radiation.

### BRIEF DESCRIPTION OF THE DRAWINGS

FIGS. 1A and 1B show infrared spectra, presented on differing scales resulting from the infrared analysis of a triacylglycerol oligomer (derived from soybean oil).

FIGS. 2A to 2C show infrared spectra, presented on differing scales, resulting from the infrared analysis of a soybean oil-derived triacylglycerol oligomer/benzophenone mixture left in the open at room temperature for over one week.

FIGS. 3A to 3C show infrared spectra, presented on differing scales, resulting from the infrared analysis of the material produced after subjecting the soybean oil-derived triacylglycerol oligomer/benzophenone mixture to UV radiation for thirty minutes.

FIGS. 4A to 4C show infrared spectra, presented on differing scales, resulting from the infrared analysis of the material produced after subjecting the soybean oil-derived triacylglycerol oligomer/benzophenone mixture to UV radiation for one hour.

FIG. 5 represents a photograph showing the results of an indentation test run on a triacylglycerol oligomer sample (to which benzophenone was added) following about 30 minutes of exposure to ultraviolet radiation.

FIG. 6 represents a photograph showing the results of an indentation test run on a triacylglycerol oligomer sample (to which benzophenone was added) following about 60 minutes of exposure to ultraviolet radiation.

FIG. 7 is a diagrammatic illustration of a system for curing/drying triacylglycerol oligomers in accordance with the present invention.

### DETAILED DESCRIPTION OF THE INVENTION

Before explaining at least one embodiment of the invention in detail, it is to be understood that the invention is not limited in its application to the details of construction, the arrangement of the components, or the details or order of the process steps set forth in the following description or illustrated in the drawings. The invention is capable of other embodiments or of being practiced or carried out in various ways.

Also, it is to be understood that the phraseology and terminology employed herein is for purposes of description and should not be regarded as limiting.

The presently claimed and disclosed invention relates, in general, to triacylglycerol oil-based oligomers and oligomer complexes which may be used as a resinous carrier for pigments which, together, form a triacylglycerol oligomer ink which can be cured by exposure to ultraviolet radiation.

A composition comprising a triacylglycerol oligomer can be cured/dried through exposure to ultraviolet radiation to form a cured product, as further described below. The triacylglycerol oligomer useful in the present invention is a non-alkyd type resin, and can be derived from the thermal polymerization of a triacylglycerol. The thermal polymerization can be either catalytic or non-catalytic. When catalytic, the typical catalyst can be a metal-containing catalyst or a non-metal catalyst. In other words, the triacylglycerol is preferably not reacted with a polyol (such as glycerol) and a polyacid (such as one of the anhydrides) to form an alkyd resin. The temperature for such polymerization can be from about 200 to about 450 C, or from about 250 to about 400 C, or from about 285 to about 350 C. The thermal polymerization can also be under a vacuum, and can include the removal of oxygen from the triacylglycerol during or prior to such polymerization, as described in U.S. Pat. No. 5,788,752 and U.S. patent application Ser. No. 10/175,651, each of which are incorporated by reference herein in their entirety.

The triacylglycerol can be selected from the group consisting of an animal fat, a vegetable oil, and combinations thereof. The vegetable oil can be selected from the group consisting of soybean oil, canola oil, corn oil, sunflower-seed oil, olive oil, safflower oil, peanut oil, cotton-seed oil, tung oil, linseed oil, palm oil, tall oil, and combinations thereof.

The triacylglycerol oligomer is generally a low molecular weight polymer. The composition can be further characterized to comprise a component selected from the group consisting of a fatty acid methyl ester, an initiator, a surfactant, a triacylglycerol oil, and combinations thereof.

The triacylglycerol oligomer is exposed to electromagnetic radiation, such as ultraviolet radiation, to form a cured product which is resistant to rub-off onto either skin or clothing. The ultraviolet radiation intensity is generally of a low level, but at a higher intensity than the ultraviolet radiation exposure intensity typically experienced from sources such as normal room lighting or exposure to sunlight. The wavelength typically associated with ultraviolet radiation is from about 10 to about 400 nm. The exposure time for the triacylglycerol oligomer to the ultraviolet radiation is generally less than about 60 minutes, or less than 30 minutes, or less than 15 minutes, which is much shorter than typical drying times for such materials not exposed to elevated levels of ultraviolet radiation. Also, the thickness of the composition comprising triacylglycerol oligomers which is subjected to ultraviolet radiation is typically less than about 5 microns, or less than 3 microns, or at least 1 micron and less than 3 microns.

The composition can also be a vegetable oil-based printing ink. The triacylglycerol oligomer can be included as at least a component of a “vegetable oil-based printing ink vehicle” or “vehicle” which can be a component of such vegetable oil-based printing ink. The vehicle is useful for carrying and dissolving pigment so that it has sufficient flow characteristics to disperse the pigment in the vegetable oil-based printing ink onto a printing surface. The vehicle can also contain triacylglycerol oil such as, but not limited to, soybean oil, canola oil, corn oil, sunflower-seed oil, olive oil, safflower oil, peanut oil, cotton-seed oil, tung oil, linseed oil, palm oil, tall oil, animal fats and the like.

The vegetable oil-based printing ink can also comprise a pigment, which can be selected from the group consisting of yellow pigment, red pigment, blue pigment, black pigment, or combinations thereof. The vegetable oil-based ink can also comprise other additives including, but not limited to, initiators, a drying agent, anti-microbial additives, surfactants, and combinations thereof. On their own, the curing performance of the ketone initiators is usually too slow to be of practical use for printing applications. Addition of amine containing molecules, photosynergists, has been found essential if ink formulations are to have essential cure speeds. See Leach and Pierce (Leach, R. H.; Pierce, R. J.; Hickman, E. P.; Mackenzie, M. J.; Smith, H. G.; “The Printing Ink Manual”, 5^{th} Edition, 1993, Blueprint), the entirety of which is incorporated herein by reference. Thus, the initiator can be either or both of a photosynergist and a photo-initiator.

The photosynergist can be selected from the group consisting of aliphatic amines, aromatic amines, and combinations thereof. Photo-initiators can be selected from the group consisting of benzophenone, benzophenone derivatives, actophenone derivatives, benzoin ether derivatives, thioxanthones, and combinations thereof. The surfactant can include, but is not limited to aromatic surfactants, fatty acids like stearic acid, and combinations thereof.

The triacylglycerol oligomer component can also comprise: 1) a high viscosity triacylglycerol oligomer, and 2) a low viscosity triacylglycerol oligomer having a viscosity lower than the viscosity of the high viscosity triacylglycerol oligomer. The high viscosity triacylglycerol oligomer can have a viscosity of at least about 1000 poise, or from about 1000 to about 2000 poise or from about 1100 to about 2000 poise. The low viscosity triacylglycerol oligomer can have a viscosity less than about 1000 poise, or from about 20 to about 1000 poise or from about 20 to about 900 poise.

The high viscosity triacylglycerol oligomer can be combined with the pigment to form a flush, and the flush can then be combined with the low viscosity triacylglycerol oligomer and any other components of the vegetable oil-based ink.

The vegetable oil-based ink can be further characterized to comprise a fatty acid methyl ester, which can aid in improving curability of the vegetable oil-based ink.

The vegetable oil-based ink can be applied to any material capable of receiving a coating of ink on its surface, and more particularly includes, but is not limited to, coated paper (such as with materials to impart certain qualities to the paper, including weight, surface gloss, smoothness, reduced ink absorbency, etc.), uncoated paper, metal, plastic, wood, natural fibers such as cotton and/or cloth made therefrom, or synthetic fibers and/or cloth made therefrom, and combinations thereof.

The material coated with the vegetable oil-based ink of the present invention can then be exposed to ultraviolet radiation to cure the ink.

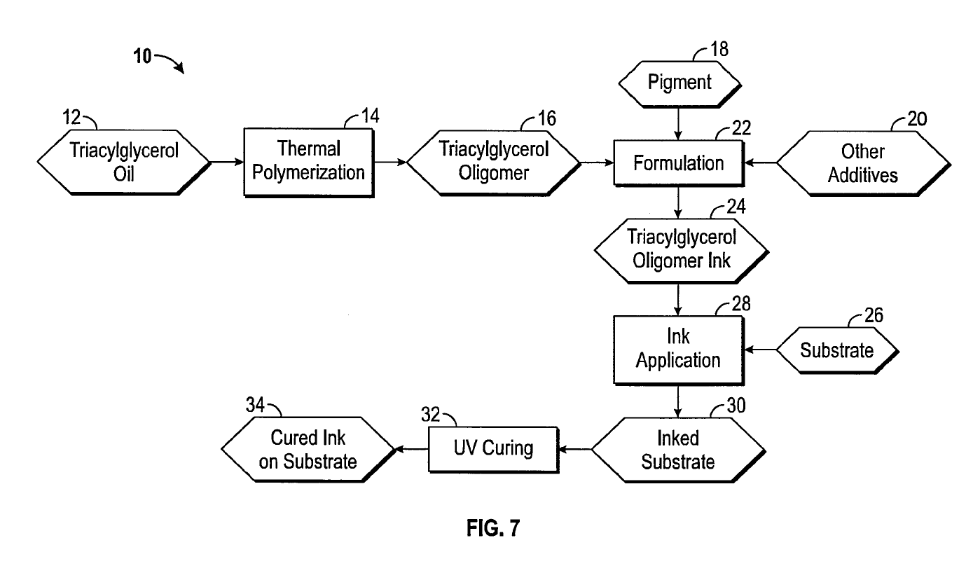

The invention will be described below with reference to FIG. 7. Process/system 10 includes passing a triacylglycerol oil 12 to a thermal polymerization step 14 wherein at least a portion of the triacylglycerol oil is polymerized to from a triacylglycerol oligomer 16. The triacylglycerol oligomer 16 is then mixed with a pigment 18, and optionally other additives 20 (described above) in formulation step 22 to thereby form a triacylglycerol oligomer ink 24. The triacylglycerol oligomer ink 24 is then applied to a substrate 26 in ink application step 28 to thereby form inked substrate 30. Inked substrate 30 is then subjected to ultraviolet radiation in UV curing step 32, thereby forming a cured ink on substrate product 34.

### EXAMPLES

### Example I

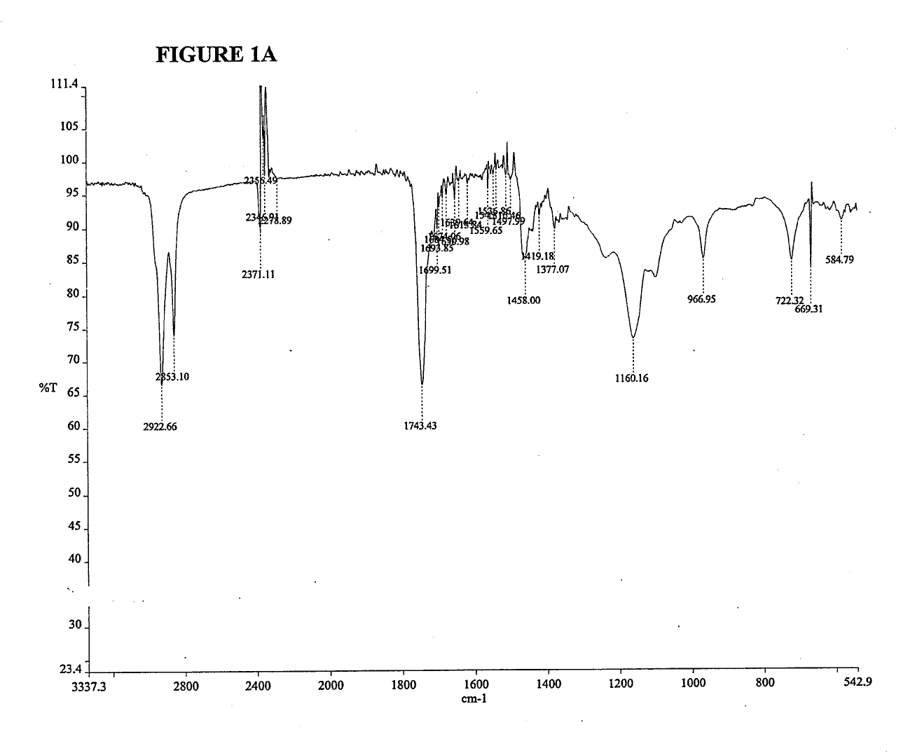

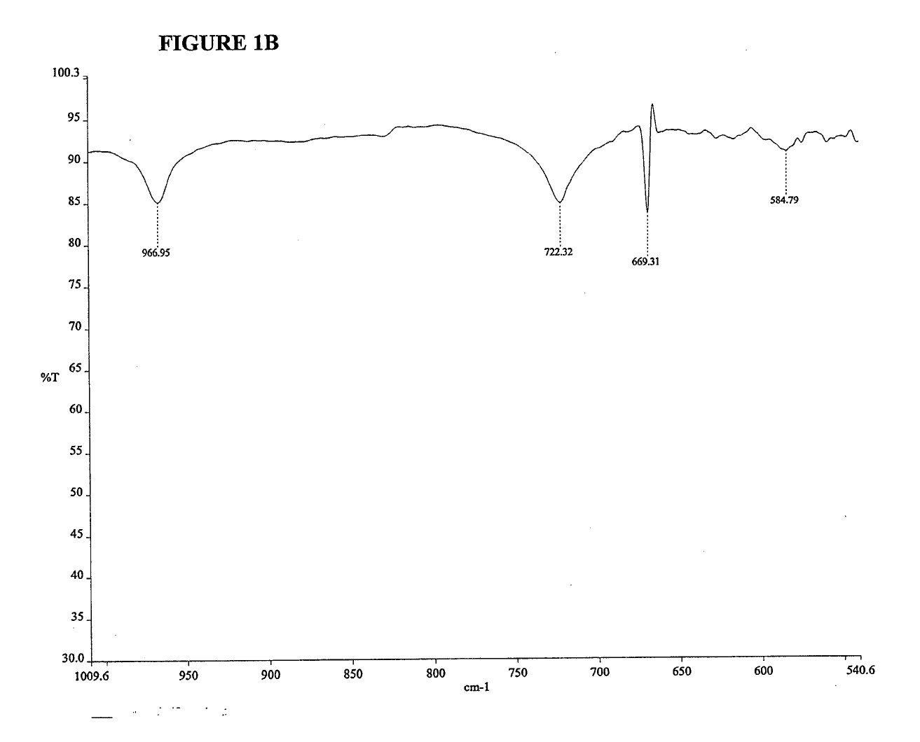

A quantity of soybean oil-derived triacylglycerol oligomer which had not been exposed to UV radiation was subjected to infrared analysis, and the spectrum for such is shown in FIGS. 1A and 1B.

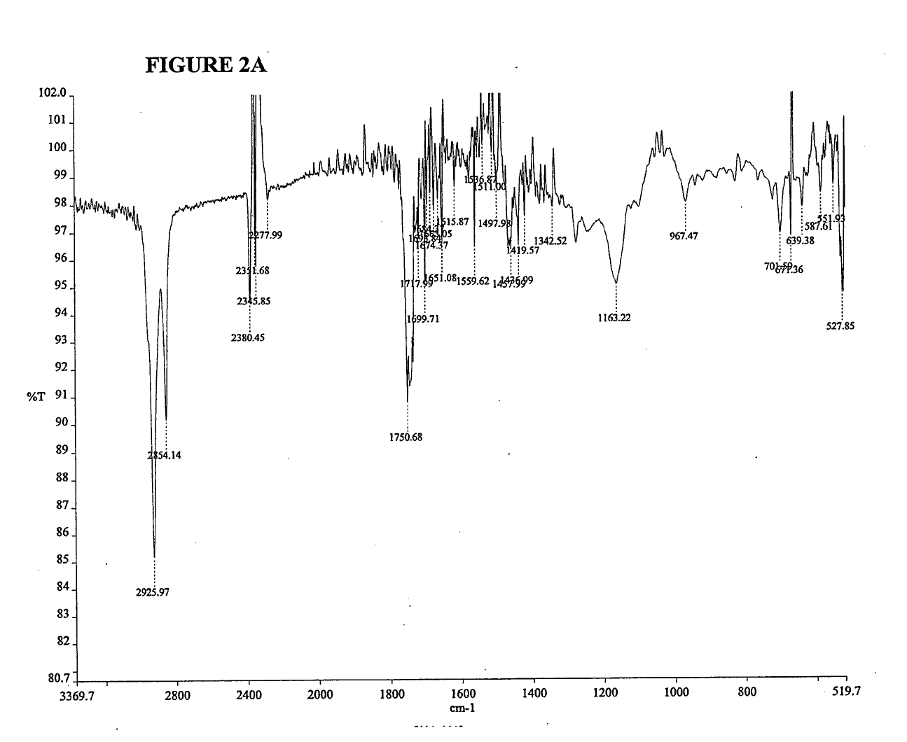

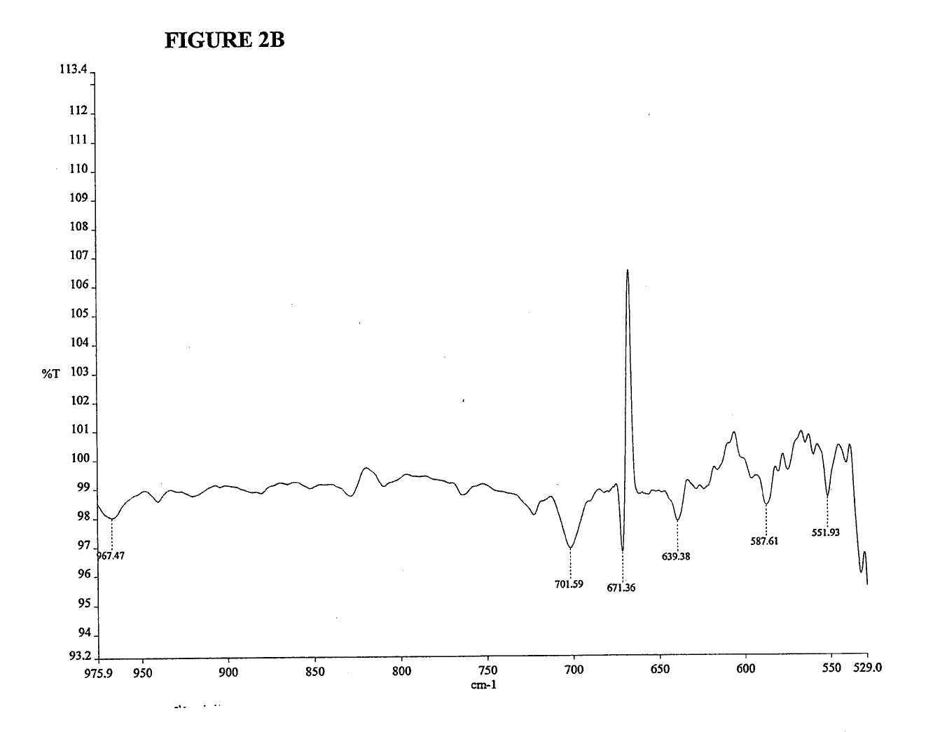

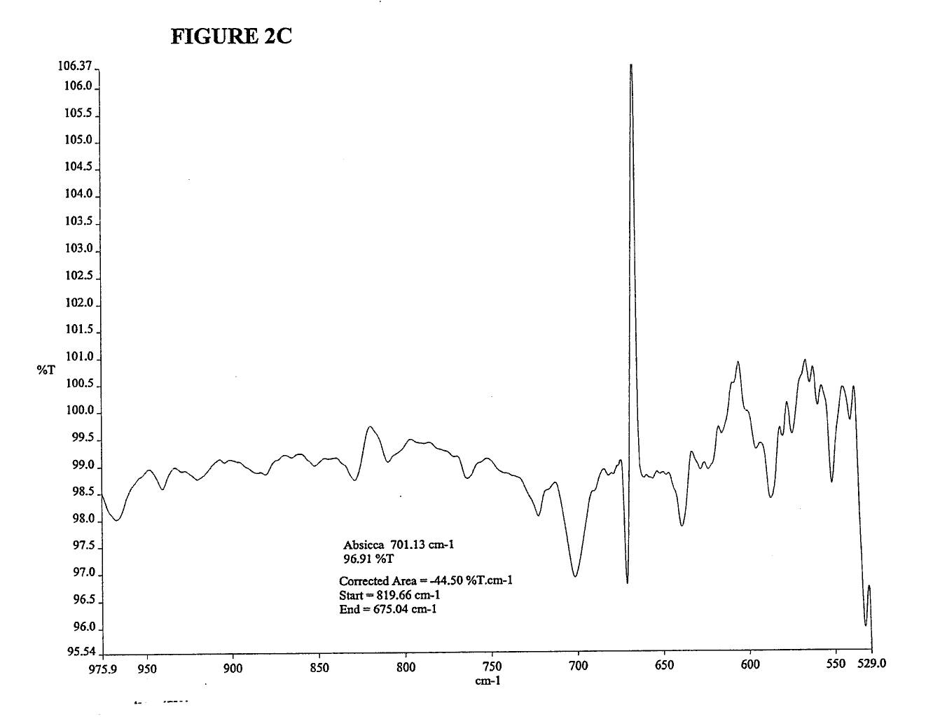

Another quantity of such soybean oil-derived triacylglycerol oligomer was mixed with a quantity of benzophenone and the mixture was left in the open at room temperature for at least one week, whereupon it was subjected to infrared analysis, and the spectrum for such is shown in FIGS. 2A, 2B and 2C. FIG. 2C also shows the peak area for the peak at 701.13 cm⁻¹, as determined through integration of the peak.

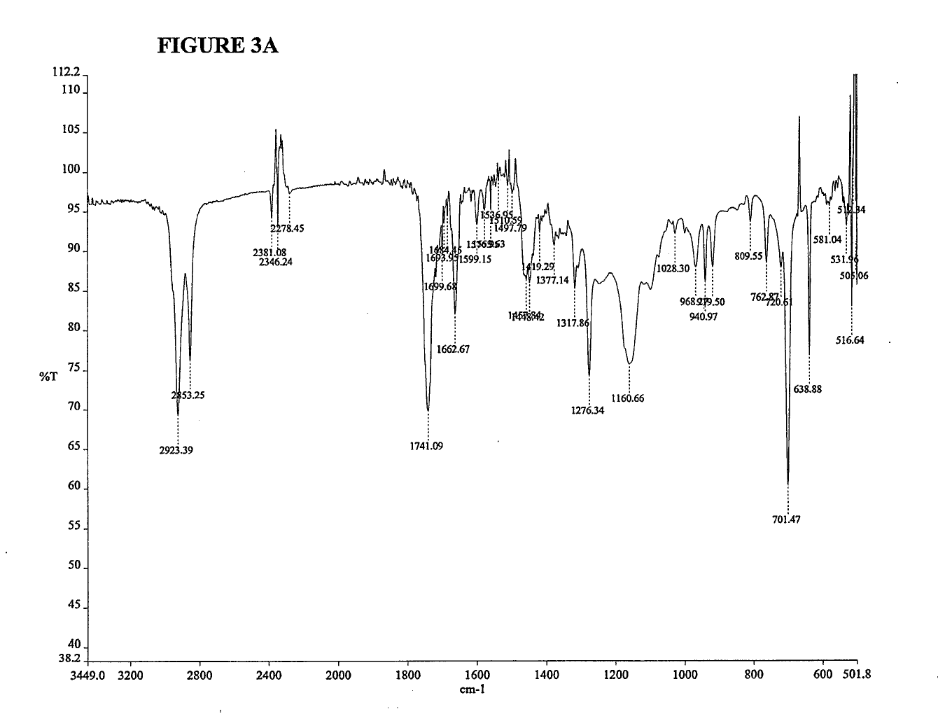

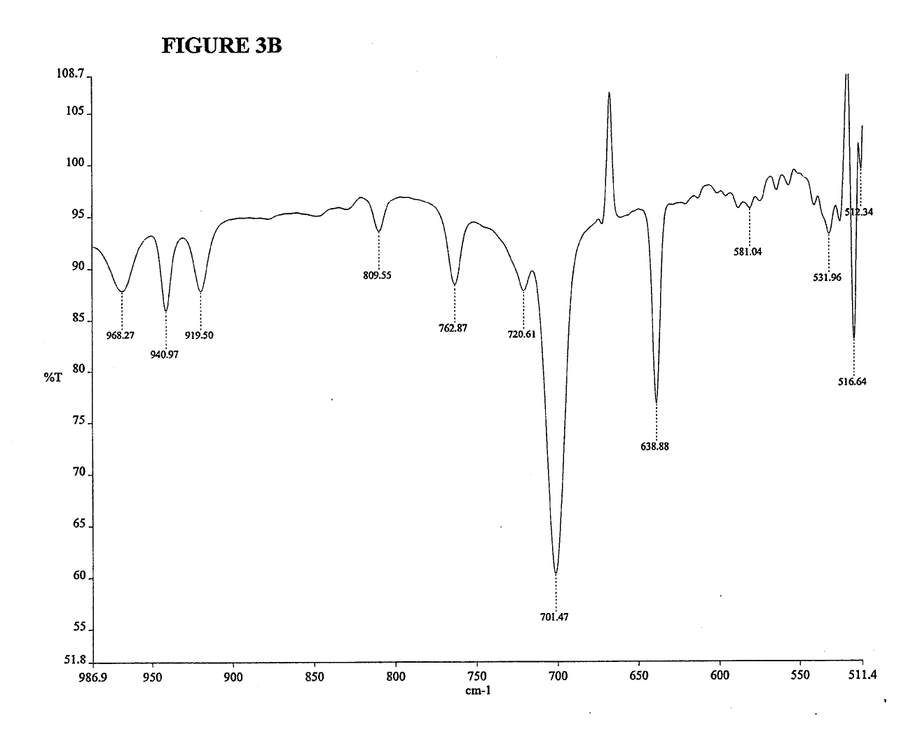

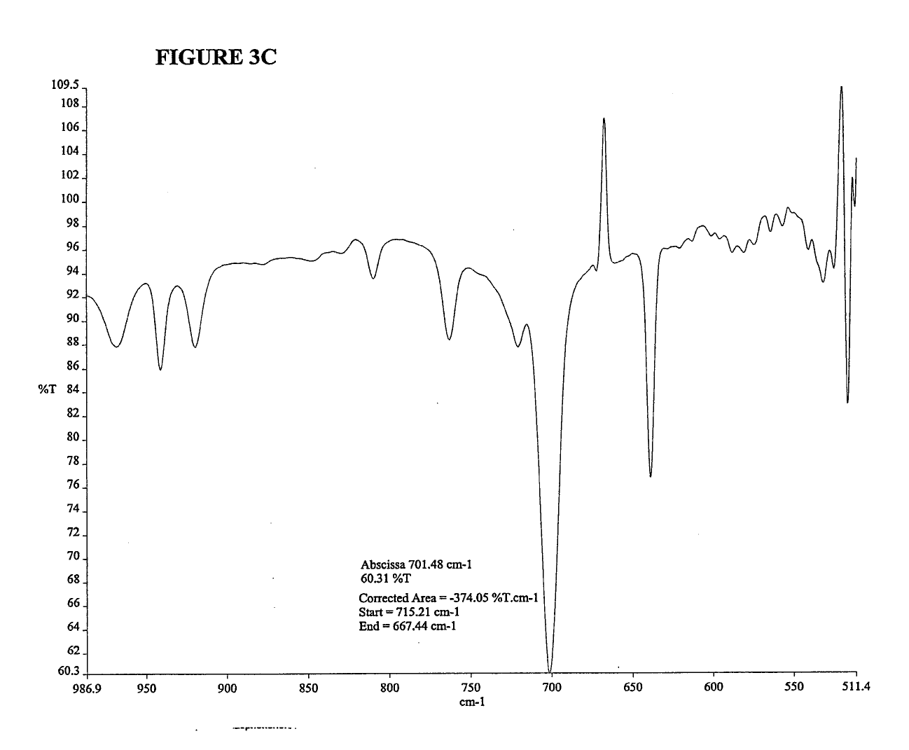

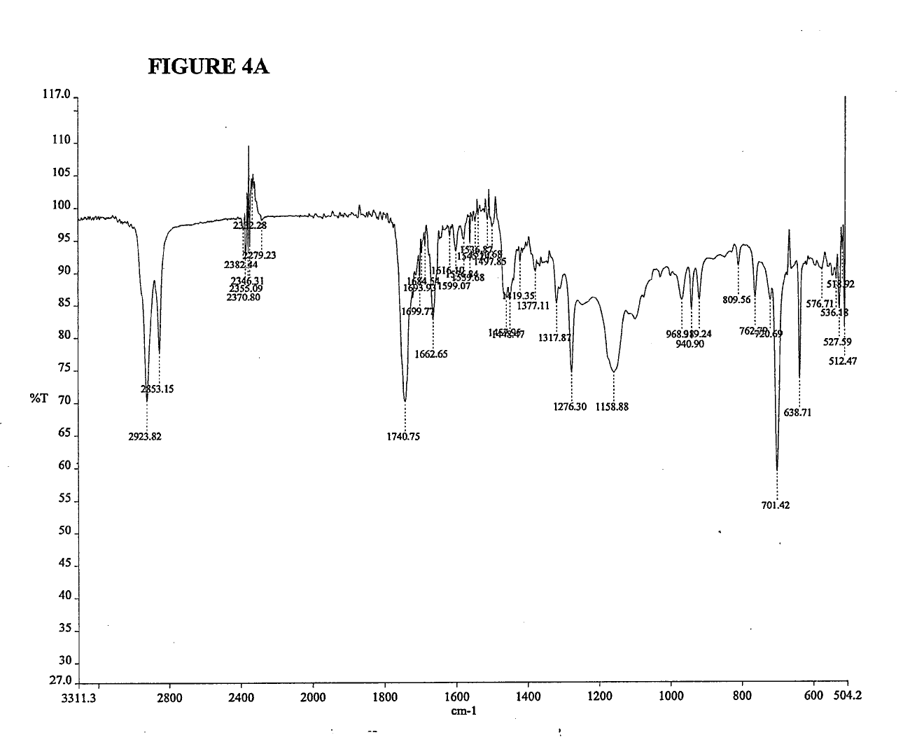

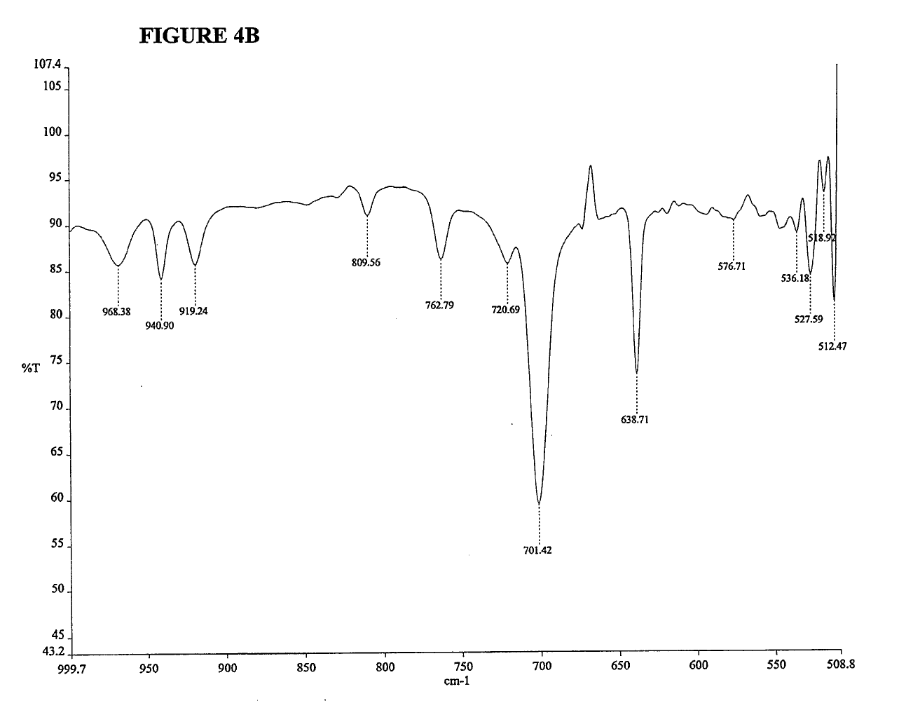

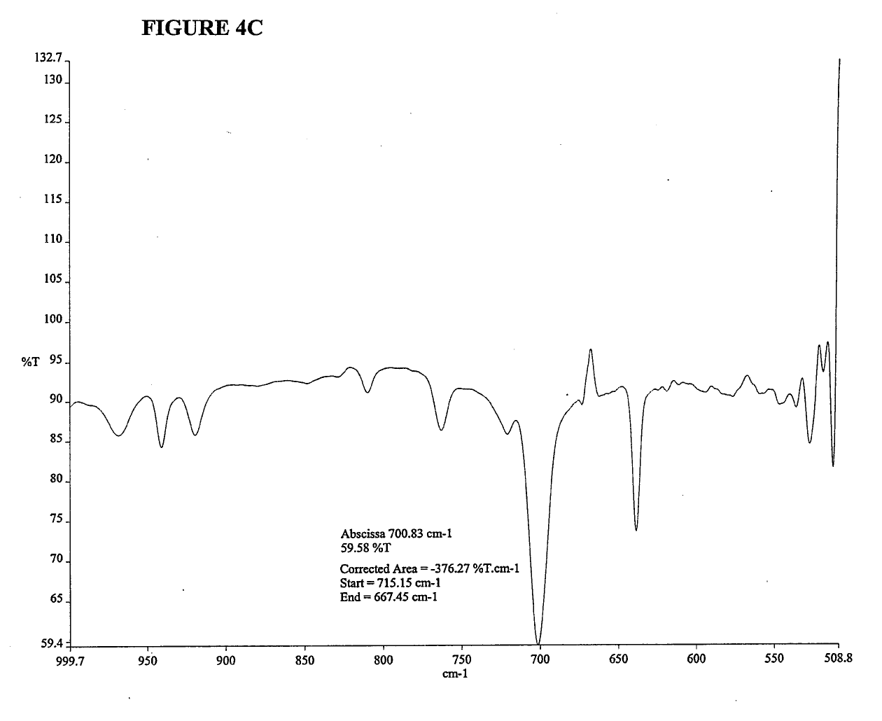

A quantity of soybean oil-derived triacylglycerol oligomer was mixed with a quantity of benzophenone and quantities of the mixture were irradiated with ultraviolet radiation using a BLE Spectroline, Model C-3F, 2.0 amps ultraviolet light box. The box contained two 0.75 amp UV lights (one light emitted UV radiation having a wavelength of about 254, and the other light emitted UV radiation having a wavelength of about 330 nm). In run 1, the soybean oil-derived triacylglycerol oligomer/benzophenone mixture was irradiated for thirty minutes before being subjected to infrared analysis, and the spectrum for such is shown in FIGS. 3A, 3B and 3C. FIG. 3C also shows the peak area for the peak at 701.48 cm⁻¹, as determined through integration of the peak. In run 2, the soybean oil-derived triacylglycerol oligomer/benzophenone mixture was irradiated for one hour before being subjected to infrared analysis, and the spectrum for such is shown in FIGS. 4A, 4B and 4C. FIG. 4C also shows the peak area for the peak at 700.83 cm⁻¹, as determined through integration of the peak.

Comparison of the IR spectra shown in FIGS. 1A through 2C with those shown in FIGS. 3A through 4C show that there are differences in the IR spectra between these materials, revealing some sort of chemical change resulting from the ultraviolet radiation exposure. In particular, FIGS. 1B, 2C, 3C and 4C reveal that strong peaks are present at around 701 cm⁻¹ in FIGS. 3C (corrected area=−374.05% T cm⁻¹) and 4C (corrected area=−376.27% T cm⁻¹), but only a weak peak is present in FIG. 2C (corrected area=−44.50% T cm⁻¹), and no peak appears to be present in FIG. 1B.

### Example II

Benzophenone was added as a photo-initiator to a soy oil-derived triacylglycerol oligomer at a ratio of 1:6. The mixture was heated between 40 and 60 C with stirring. Print film thickness is estimated to be 1-3 micrometers by Leach and Pierce. In particular, refer to pp. 636-671 of Leach and Pierce. Samples were drawn down on each row of a grind gauge to observe curing and the corresponding film thickness. The samples were then exposed to UV radiation. The extent of curing was estimated by placing a round 50 gram weight for 5 seconds on the sample at various film thicknesses on the grind gauge and observing whether a ring was formed due to the resin not being cured.

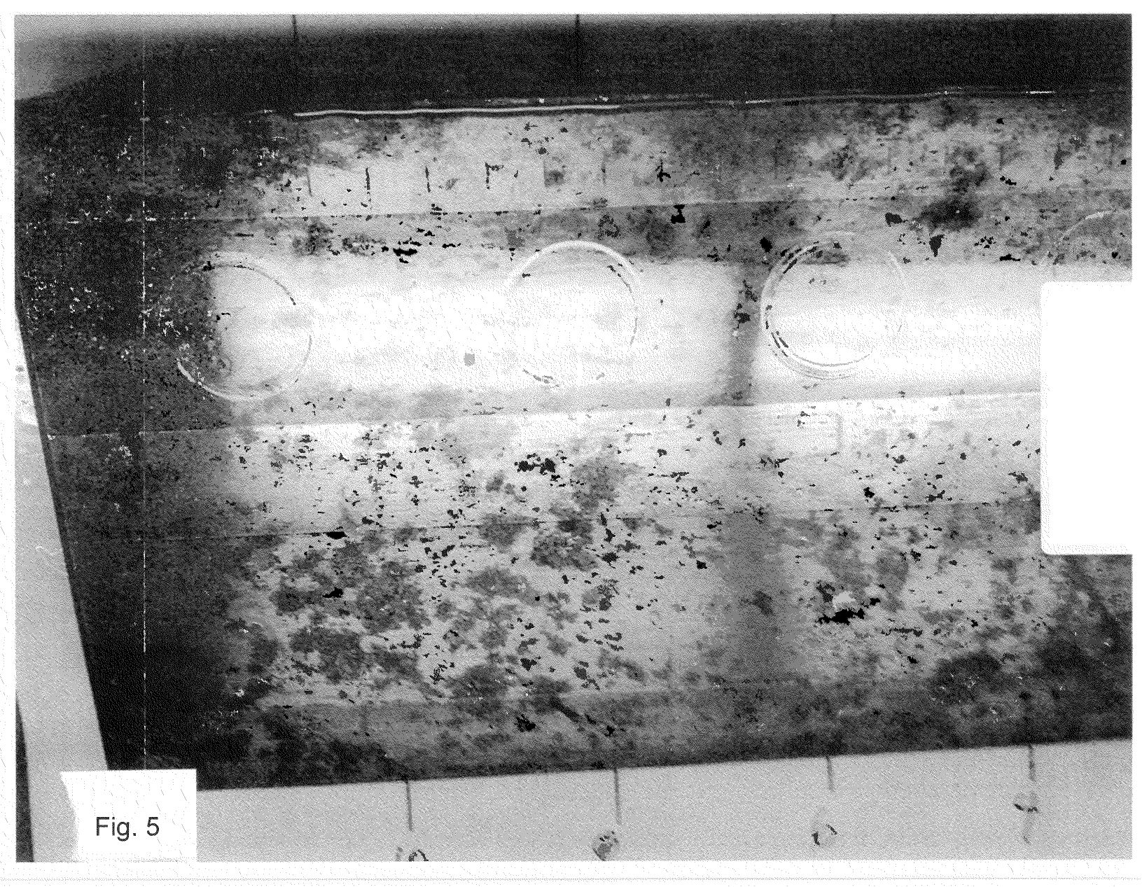

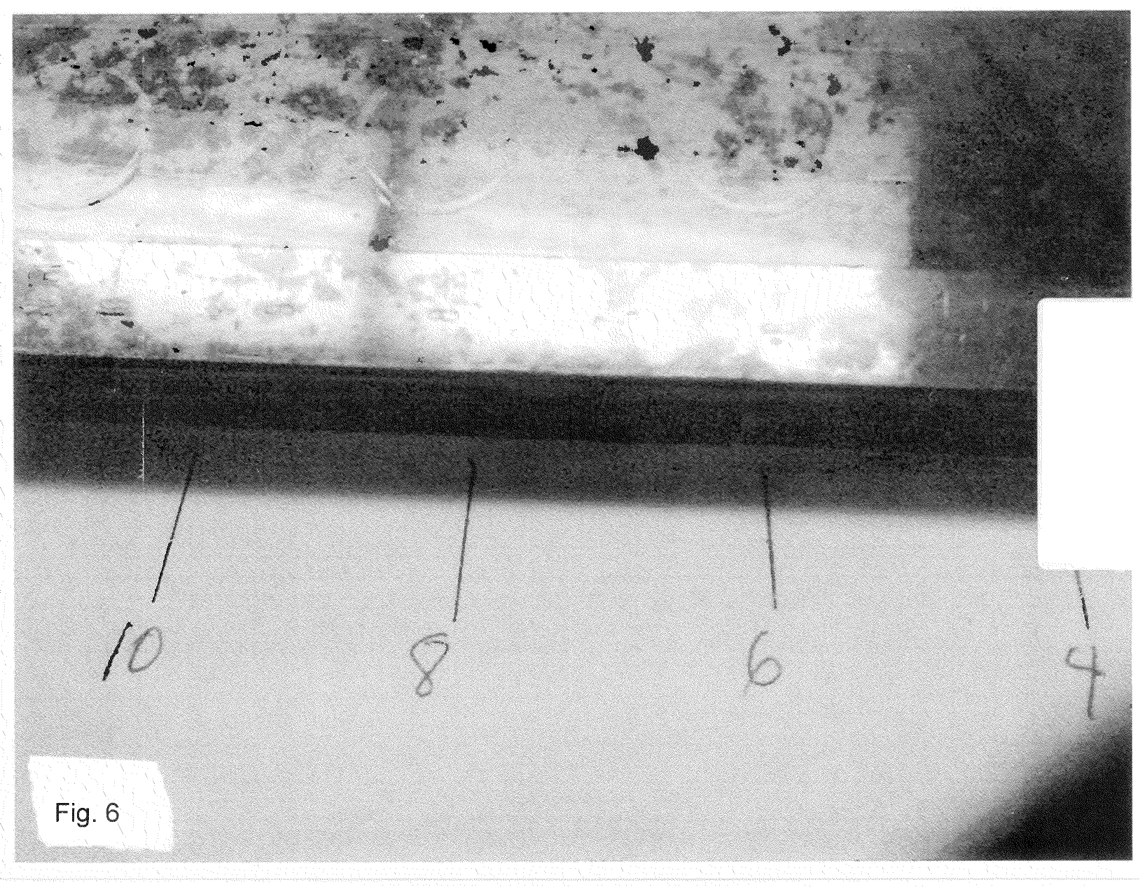

In the first test a sample was exposed to UV radiation for a total of about thirty minutes, and in the second test a different sample was exposed to UV radiation for a total of about sixty minutes. FIG. 5 represents a photograph showing the indentation results for the first test (about thirty minutes of exposure), and FIG. 6 represents a photograph showing the indentation results for the second test (about sixty minutes of exposure).

The numbers shown on the photographs represent NPIRI particle size or, for these experiments, the film thickness. The numbers 10, 8, 6 and 4 correspond to a film thickness of 25, 20, 15, and 10 micrometers, respectively.

Close examination of the indentations shown in FIGS. 5 and 6 indicate that the indentations: (1) decreased with increasing exposure time, and (2) decreased as film thickness decreased.

### Example III

Formulations of a soy oil-derived triacylglycerol oligomer and other components were prepared in accordance with Table 1 below.

TABLE 1

| | Formulation A | | Formulation B | |
|---|---|---|---|---|
| Component | Mass, g | Weight % | Mass, g | Weight % |
| Triacylglycerol Oligomer | 26.0 | 52.1 | 26.0 | 52.1 |
| Triacylglycerol | | | | |
| Soybean oil | 15.4 | 30.8 | — | — |
| Canola oil | — | — | 15.4 | 30.8 |
| Benzophenone | 5.7 | 11.4 | 5.7 | 11.4 |
| n-methyl diethanolamine | 2.9 | 5.7 | 2.9 | 5.7 |
| Total | 50 | 100 | 50 | 100 |

Formulations A and B were prepared by:

Step 1: Mixing the benzophenone and amine components with the triacylglycerol until completely dissolved (with the addition of some heat).

Step 2: The triacylglycerol oligomer was added to the mixture from Step 1 and stirred until completely dissolved.

Step 3: A sample of the formulation (whether A or B) from Step 2 was drawn down on a substrate using a grind gauge to thicknesses ranging from above 0 to 25 microns and the substrate coated with the sample was placed in an ultraviolet (UV) light box containing four 15 kW UV lights. Two of the lights emitted UV radiation having a wavelength of about 254 and the other two emitted UV radiation having a wavelength of about 394.

Step 4: The sample coated substrates were removed from the UV light box after the time intervals shown in Tables 2 and 3 below and the samples were subjected to testing, as discussed below, to determine the cure times.

### Determination of Cure Times

ASTM D1640-03—Cotton Fiber Test Method

The cure times for the samples were determined using the Dust-Free Time (Cotton Fiber Test) method set out in paragraph 7.3 of ASTM D1640-03 (Reapproved 2009).

100% Natural Cotton Balls were used for the test. A number of individual fibers were separated from a cotton ball with the aid of tweezers. Several of the cotton fibers were dropped from a height of 25 mm (1 in.) onto the film at a section between from 0 to 5 microns film thickness. The film was considered to have dried dust free when the cotton fibers were able to be removed by blowing lightly over the surface of the film. If fibers remained on the film after blowing lightly, then the sample was designated as failing the test. The results of the testing are shown in Table 2 below.

TABLE 2

| Cure Time in | Formulation A | Formulation B |
|---|---|---|
| UV light box | Pass/Fail Cotton | Pass/Fail Cotton |
| (minutes) | Fiber Test Method | Fiber Test Method |
| 15 | Pass | Pass |
| 30 | Pass | Pass |
| 60 | Pass | Pass |
| 75 | Pass | Pass |

As can be seen from the data, the films from formulations A and B each passed the Cotton Fiber Test after only 15 minutes of curing in the UV light box.

Permanganate Staining Test

The level of curing at the different time intervals were evaluated using the Permanganate Staining Test, as described below.

STEP 1: A 1% solution of potassium permanganate was prepared in deionized water.

STEP 2: Using an eye dropper, two drops of potassium permanganate solution were applied to the film at a section between from 0 to 5 microns film thickness.

STEP 3: The solution was allowed to remain in contact with the film for five minutes and was then rinsed with water.

STEP 4: In the 5 micron area where the solution was in contact with the film, a brown stain was apparent.

STEP 5: The color and intensity of the brown stain was determined using a Lovibond Tintometer. The Tintometer was calibrated to a zero Relative Color Density using a non-stained film sample.

The results of the color and intensity measurements are presented in Table 3 below.

TABLE 3

| Cure Time in | Formulation A | Formulation B |
|---|---|---|
| UV light box | Relative Color Density | Relative Color Density |
| (minutes) | Permanganate Staining Test | Permanganate Staining Test |
| 15 | 1.20 | 1.30 |
| 30 | <1.00 | 1.00 |
| 60 | <1.00 | <1.00 |
| 75 | <1.00 | <1.00 |

As can be seen from the data, the films from formulations A and B showed marked decreases in Relative Color Density after 30 minutes of curing in the UV light box, with the film for formulation A having a Relative Color Density less than 1.00 after the 30 minutes.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, unless expressly stated otherwise, the term “about” as used herein is intended to include and take into account variations due to manufacturing tolerances and/or variabilities in process control.

Changes may be made in the steps or sequence of steps of the methods described herein, and changes may be made in the construction and the operation of the various components, elements and assemblies described herein without departing from the spirit and the scope of the invention as defined in the following claims.

What is claimed is:

1. A process for curing a composition comprising a triacylglycerol oligomer comprising exposing said composition to ultraviolet radiation to form a cured product.

2. The process of claim 1 wherein the triacylglycerol oligomer is exposed to the ultraviolet radiation for a time period less than about 60 minutes.

3. The process of claim 1 wherein said triacylglycerol oligomer is derived from the thermal polymerization of a triacylglycerol oil.

4. The process of claim 3 wherein the thermal polymerization of said triacylglycerol is at a temperature of from about 200 to about 450 C.

5. The process of claim 3 wherein said triacylglycerol oil is selected from the group consisting of an animal fat, a vegetable oil, and combinations thereof.

6. The process of claim 1 wherein said triacylglycerol oligomer is a non-alkyd low molecular weight polymer.

7. The process of claim 1 wherein said composition is further characterized to comprise an initiator.

8. The process of claim 7 wherein said initiator is selected from the group consisting of a photosynergist, a photo-initiator, and combinations thereof.

9. The process of claim 8 wherein said photosynergist is selected from the group consisting of aliphatic amines, aromatic amines, and combinations thereof, and wherein said photo-initiator is selected from the group consisting of benzophenone, benzophenone derivatives, actophenone derivatives, benzoin ether derivatives, thioxanthones, and combinations thereof.

10. The process of claim 8 wherein said photo-initiator is benzophenone.

11. The process of claim 1 wherein said triacylglycerol oligomer comprises: 1) a high viscosity triacylglycerol oligomer, and 2) a low viscosity triacylglycerol oligomer having a viscosity lower than the viscosity of said high viscosity triacylglycerol oligomer.

12. The process of claim 11 wherein said high viscosity triacylglycerol oligomer has a viscosity of at least about 1000 poise, and said low viscosity triacylglycerol oligomer has a viscosity lower than about 1000 poise.

13. The process of claim 11 wherein said composition is further characterized to comprise a pigment, and wherein said high viscosity triacylglycerol oligomer is combined with said pigment to form a flush, and said flush is combined with said low viscosity triacylglycerol oligomer.

14. The process of claim 13 wherein said composition is further characterized to comprise a component selected from the group consisting of a fatty acid methyl ester, an initiator, a surfactant, a triacylglycerol oil, and combinations thereof.

15. The process of claim 1 wherein said composition is applied as an ink to the surface of a material prior to exposing said composition to said ultraviolet radiation to form said cured product.

16. A cured product produced by the process comprising exposing a composition comprising a triacylglycerol oligomer to ultraviolet radiation to form said cured product.

17. The cured product of claim 16 wherein said triacylglycerol oligomer is a non-alkyd low molecular weight polymer.

18. The cured product of claim 16 wherein said composition is further characterized to comprise an initiator selected from the group consisting of a photosynergist, a photo-initiator, and combinations thereof.

19. The cured product of claim 18 wherein said composition is further characterized to comprise a fatty acid methyl ester, and a surfactant.

20. The cured product of claim 16 wherein said composition is applied as an ink to the surface of a substrate prior to exposing said composition to said ultraviolet radiation to form said cured product.
